(19) United States
(12) Patent Application Publication
(10) Pub. No.: US 2003/0037063 A1
(43) Pub. Date: Feb. 20, 2003

(54) Method and system for dynamic risk assessment, risk monitoring, and caseload management

(75) Inventor: David R. Schwartz, Philadelphia, PA (US)

Correspondence Address: MORGAN LEWIS & BOCKIUS LLP, 1111 PENNSYLVANIA AVENUE NW, WASHINGTON, DC, 20004, US

(73) Assignee: QLINX

(21) Appl. No.: 09/925,558

(22) Filed: Aug. 10, 2001

(51) Int. Cl. G06G 7/00

(52) U.S. Cl. 707/104.1

(57) ABSTRACT

A system and method for assessing risk, monitoring risk, and managing caseloads of individuals under risk assessment is provided. The system includes a network server computer that stores into memory information regarding each individual's environment, behavior, physical condition, personal relationships, and/or mental state of being. Similar information regarding other individuals associated with the individual being assessed for risk also may be stored in the server memory. Individuals under risk assessment, individuals associated with individuals under risk assessment, and workers responsible for overseeing individuals under risk assessment may input this information into the server memory. The server processes this information for input into a risk assessment application that may include a fuzzy logic, neural network, neuro-fuzzy, or other artificial intelligence software or hardware to compute a composite risk score. The system provides workers an alarm signal when an individual's assessed score exceeds a predetermined level. The system provides workers an alarm signal when an assessed score of an individual exceeds a predetermined level or falls into a predetermined classification category. Worker caseloads are automatically updated and/or prioritized by the system in accordance with alarm signals present in the server database. The system and method also provide individuals accessing the system with helpful resources based on information they provide the system server, and a means for communication between system users.

### FIELD OF THE INVENTION

The present invention relates to communicating, computing, monitoring and managing risk levels for individuals in high-risk environments. In particular, the system and method of the present invention provides a unique method and system for monitoring risk factor variables to provide for continuously updated accurate risk assessments.

### BACKGROUND OF THE INVENTION

Most civilized societies today place high value on the safety and welfare of all their members. It is an ideal of a civilized society that each member exist and function within laws that define the society, and that everyone be given a chance to live freely and without fear that harm may come to them.

Unfortunately, while our present social system strives for perfection along these lines, we live in an imperfect world where many individuals are not given the opportunity or do not possess the ability to exist and function in a safe environment. Some simply refuse to obey the laws and choose instead to prey on others, depriving them of the safety and welfare that society strives to provide them. In each of these cases, one or more individuals may be at risk for committing harmful actions to others, or of being a recipient of another's harmful action. If society can identify whether these risks are substantially present at any given time, it can intervene and prevent harm from occurring to its members.

In our present society, departments and agencies, such as Health and Human Services, are charged with evaluating and monitoring whether individuals are at high risk. For example, social workers in the fields of child welfare and juvenile justice often carry a major burden of responsibility for the well being of children and families under their watch. To provide a safe environment for children overseen by a child welfare or justice system, social workers evaluate various factors pertinent to each child and his or her surroundings to assess whether the child is at risk for abuse or neglect, arrest, graduation into the adult criminal justice system, violent crime, elopement (running away from a facility), etc. When an assessment of risk is determined to meet or exceed a predetermined value, intervention is initiated to remove the child from the dangerous environment or take other appropriate measures.

Individuals under the advice, direction or supervision of counselors or health care providers, such as mental health outpatients, mentally challenged individuals, and drug and/or alcohol abusers, also face unexpected situations and circumstances that may place them into high-risk status. For example, a drug abuser faces uncontrollable addictive urges. These urges, and adverse and/or destructive behavior that may accompany them, can be triggered from the abuser's environment or state of mind. Similarly, supervised individuals diagnosed with mental health conditions, such as bipolar schizophrenia or manic-depression disorder, also experience uncontrollable behavior that may place them into risk for harming themselves or others.

In either mental health or drug/alcohol abuse categories, an individual's behavior, physical condition, various environmental conditions and psychological state can be described and measured to allow a counselor or health care provider to appraise risk for that individual. For example, among drug abusers, these measurements may be used to assess risk for relapse of drug use, or criminal and/or violent behavior. For mental health outpatients, examples of risk appraisal can include assessments for self-destructive actions, harm to others, return to institutional care, or whether the outpatient would stop self-medication. For children in different phases of the child welfare system, these measurements can be used to assess overall risk to the child in his/her current care giving environment. In any case, when an assessed risk score exceeds an acceptable level, intervention can be initiated to prevent catastrophic events from occurring.

Other areas of risk assessment include individuals under the supervision of adult corrections subject to various risks, such as risk for returning to criminal behavior, abusive and/or violent behavior, or returning to prison. Risk assessment may be performed for these individuals in a fashion similar to child welfare, juvenile justice, mental health, or drug/alcohol abuse, where an individual's environment, behavior, physical condition, etc. are measured to define factors for risk assessment.

A known way of performing risk assessment involves an actuarial based grading system from which a composite risk score is determined. Data obtained by periodically monitoring an individual's environment, behavior, physical condition and mental state of being is compiled through examination, investigation, and/or interviews to create a profile of factors called risk assessment variables.

In child welfare, data obtained by periodically monitoring a child and the child's environment is compiled to create a profile of factors, such as the child's sex and age, ages of the parents, employment status of the parents, household income, cleanliness of the home, past history of abuse, etc. Each of these is a variable for input into a mathematical equation computing a risk assessment composite score for the child. When evaluating variables, each are given a score based on a scale or weight. A typical scale runs from 0 to 5 or 0 to 3, where, for example, a very clean home would receive a “0,” but a messy, foul smelling home scores “5” or “4.”

A typically relevant risk assessment variable involves age. When performing actuarial-based risk assessment, a child welfare case reporter will determine a risk related weight associated with the child's age. For example, it is known that a two month old infant is far more vulnerable to harm than a four year old, a nine year old is less vulnerable than a five year old, and so on. Based on this knowledge, an aged-based score for the two month old baby may be set at “5” (high risk), a “3” (medium risk) for the five year old, and a “1” (relatively low risk) for a ten year old. When a child reaches an age where most age sensitive risk factors, such as shaken baby syndrome, eventually drop to low levels, a weight of zero may be assigned the age factor for that variable.

For individuals in adult corrections, age variables may be weighted in broader ranges. For example, a supervised individual in his or her late teens or early twenties or thirties is generally more prone to a relapse of criminal behavior than a thirty or fourty year old.

Individuals being assessed for risk of criminal behavior within an adult corrections system may additionally have a mental disorder that requires a more specialized risk assessment. In this situation, the sensitivity of a weighted age variable to risk assessment may be irrelevant when compared with an individual without a mental disorder, but whose crime history is identical.

Other problems frequently arise because of mathematics used in actuarial risk assessment methods. Weighted variables unintentionally cancel out one another when using rigid scales to handicap variables. For example, the weighted age related risk factor for a two-month-old child might cancel out, or downgrade the importance of, a variable weighted to represent an exceptionally clean home.

Known actuarial methods suffer in that they impose rigid standards when weighting risk assessment variables. The above child welfare example fails to reflect that in reality a two-month old baby is substantially more vulnerable than a four year old, and there are huge differences in risk between a two month old and a four year old. Thus, while the risk weight assigned here appears to vary in a constantly changing and often nonlinear way, a reporter must choose rigid steps scored as one, three or five. Moreover, a child's age related risk factor can immediately and unrealistically fall to three, one and zero in step-like fashion on the child's fifth, tenth, and fourteenth birthdays.

Conventional actuarial methods of risk assessment are also slow to respond to evolving social problems. As an example, drug abuse by household members is a major factor in influencing abuse or neglect risk assessment for children. Parents swept up in the crack epidemic of the 1980's, an evolving problem, generally presented a much higher risk to their children, themselves and society, than drug abusing parents before the onslaught of crack. By the time these evolving risk factors were incorporated into conventional risk assessment methods, many children had already suffered from undetected high levels of risk.

Further problems with known risk assessment methods involve reporting frequency. For example, while child welfare caseworkers generally schedule update interviews at intervals deemed most appropriate for each particular situation, child deaths continue to occur. As another example, on any given day, a juvenile justice client may meet with a counselor, and his or her current progress and condition may appear satisfactory. However, a day later, even an hour later, the client's status can appreciably change for the worse. Similarly, individuals suffering from mental health and drug and alcohol conditions may experience unexpected and uncontrollable behavior very soon after an assessment of risk status. Although an increase in reporting and risk assessment frequency would facilitate accurate risk status, it is an increasingly difficult task for caseworkers, counselors, parole officials, or health care providers, etc. to increase frequency of contact with their clients because caseloads are typically very large and resources are scarce. Client access to the caseworker similarly may be difficult at times due to large caseloads.

Frequent status updates, however, are essential for coping with problems that often arise between reporting intervals. These problems can quickly escalate to a point where, unknown to the reporter, an individual's risk assessment jumps to dangerously high levels. For example, in a household that once would be scored as a medium to high “home income” risk factor, the 21-year-old father could lose his job on any given day. Now he is home 24 hours a day with his two-month-old child. The father's stress level, already high before his job termination, has now reached a severely high level. This potentially dangerous situation changes the child's overall risk status, but this change remains unknown to the child welfare reporter until the next scheduled status update. Awareness of developing risk increases with more frequent reporting; however it is impractical to expect a caseworker to track every household on her docket with high frequency. That professional charged with monitoring risk has limited time to allocate each client under her watch. This limited time must also be divided among a number of clients that, in high probability, have several different levels of crises brewing simultaneously.

Thus, it can be seen that conventional methods and systems for monitoring, managing and assessing risks that individuals face have significant limitations when applied to meet the demands our society makes for the safety and welfare of each of its members.

At the same time, advances in computer processing power, wireless communications, and network communications have made information from a wide variety of sources available on shared computer networks. Computer and wireless device networking allows networked computers and wireless devices to share information, software applications and hardware devices. Internetworking enables a set of physical networks to be connected into a single network such as the Internet. Today, computers and wireless devices connected to the Internet have almost instant access to information stored in relatively distant regions. Moreover, computers connected to networks other than the Internet also have access to information stored on those networks. The World Wide Web (Web), a hypermedia system used on the Internet, enables hypertext linking, whereby documents automatically reference or link other documents located on connected computer networks around the world. Thus, users of computers and wireless devices connected to the Internet have almost instant access to information stored in relatively distant regions.

A page of information on the Web may include references to other Web pages and may include a broad range of multimedia data including textual, graphical, audio, and animation information. Typically, information is retrieved from the Internet, through the Web, by “visiting” or accessing a web site on a computer that is connected to the Internet.

A Web site is, in general terms, a server application that displays information stored on a network server computer. The web site accepts connections from client programs, such as Internet browser applications. Browser applications, such as Microsoft Internet Explorer™ or Netscape Navigator™, allow Internet users to access information displayed on the Web site. Most browser applications display information on computer screens and permit a user to navigate through the Web using a mouse. Like other network applications, Web browsing uses the client-server paradigm. When given the Uniform Resource Locator (URL) of a document, the browser application becomes a client and it contacts a server application specified in the URL to request the document. After receiving the document from the server application, the browser application displays the document. Typically, when the browser application interacts with the server application, the two applications follow the HyperText Transport Protocol (HTTP). HTTP allows the browser application to request a specific article, which the server application then returns. To ensure that browser applications and server applications inter-operate unambiguously, HTTP defines the exact format for requests sent from the browser application to the server application as well as the format of replies that the server application returns.

As the number of physical networks connected to the Internet continues to grow, so too will the number of computer applications that utilize networked information. Network related applications generally offer enhanced accessibility to computing power. Rapid growth of public accessible networks such as the Internet will soon make easy access ubiquitous in our society.

It is desirable for clients being monitored to have increased accessibility to a system for updating risk variables, thus allowing for risk assessments on a more continuous or real-time basis. It also is desirable to have a risk assessment method and system in which variables can be weighted in a more fluid and continuous manner. It further is desirable to have a method and system for weighting variables to calculate a risk assessment with increased accuracy. Also desirable is a system that can quickly adjust variable weights for changing or evolving social conditions affecting risk computations. Further, it is desirable to have a system that produces a signal to alert those responsible for monitoring and managing risk when risk levels change. It further is desirable to present a user-friendly system environment where clients may find helpful resources, thus providing incentives to update status in the system, and a place to turn to for help in finding solutions to a crisis situation.

### SUMMARY OF THE INVENTION

Accordingly, the present invention is directed to a network based method and system for risk assessment, risk monitoring and caseload management that substantially obviates one or more of the problems due to limitations and disadvantages of the related art. In particular, the present invention is directed to a risk assessment, risk monitor, and case management method and system that allows a risk assessed individual and other individuals associated with the assessed individual to access a computer running the system through an extended network, such as the Internet, and update data related to risk assessment stored in the system.

An aspect of the present invention is to provide a network based risk assessment system that is accessible to the individual being assessed as well as to other individuals with knowledge of the client's environment, behavior, physical condition and mental state of being.

Another aspect of the present invention is to provide a method of risk assessment where relative weights of risk assessment variables are determined and refined to produce accurate assessments.

Another aspect of the present invention is to provide a method of determining a risk assessment that quickly adjusts to account for evolving risk factors.

A further aspect of the present invention is to provide an alarm signal that alerts those responsible for monitoring risk level when a risk assessment level changes.

Yet still another aspect of the invention is to provide a method and system for organizing dockets of caseworkers charged with monitoring and assessing risk.

Yet another aspect of the invention is to provide a method and system for prioritizing dockets of caseworkers charged with monitoring and assessing risk.

Another aspect of the present invention is a system that assesses risk on the fly depending on updates and input from clients and other information providers.

Additional aspects and advantages of the invention will be set forth in the description that follows, and in part will be apparent from the description, or may be learned from practice of the invention. The aspects and advantages of the invention will be realized and attained by the system and method particularly pointed out in the written description and claims hereof as well as the appended drawings.

It is to be understood that both the foregoing general description and the following detailed description are exemplary and exemplary only and are not restrictive of the invention, as claimed.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention. In the drawings:

FIG. 1 illustrates a computer network in which the inventive system may be incorporated;

FIG. 2 illustrates the TCP/IP Layering Model Protocol used during communications between components on the computer network;

FIG. 3 illustrates system components for the risk assessment, risk monitoring and caseload management system of the present invention;

FIGS. 4(a)-4(c) illustrate processes for the risk assessment, risk monitor and managing system of the present invention;

FIGS. 5(a)-5(c) illustrate exemplary query Web pages of the present invention;

FIG. 6 is a schematic diagram of a fuzzy logic expert system that may be used in the present invention;

FIG. 7 is an illustration of typical fuzzy logic rule membership functions;

FIG. 8 is an illustration to conceptually show how a fuzzy logic inference engine computes an output;

FIG. 9 is a schematic diagram of a neural network having an input layer, a hidden layer, and an output layer; and

FIGS. 10a and 10b are schematics of neuro-fuzzy system that may be used in the present invention.

### DESCRIPTION OF THE PREFERRED EMBODIMENTS

Reference will now be made in detail to the preferred embodiments of the present invention, examples of which are illustrated in the accompanying drawings.

The present invention provides a system and method for assessing, monitoring, and managing risk levels of individuals in high-risk environments. When the present invention is utilized by a child protective services agency, an assessment indicative of a risk is made available to those overseeing or investigating a child. Types of risk facing children within human services settings such as agencies dealing with child welfare and juvenile justice include several risk categories for which the present invention can be used. These include risk for abuse and/or neglect, risk for arrest, risk for failure in different home-based or other juvenile justice programs, risk for abuse in detention facilities, risk for “graduation” into the adult criminal justice system, risk for violent crime, and risk for elopement.

The present invention is useful to assess risk of individuals under the advice, direction or supervision of counselors or health care providers, such as mental health patients and drug and/or alcohol abusers. In the area of mental health, areas of risk include, but are not limited to, re-institutionalization of outpatients, risk of patients harming themselves, risk of patients harming others, whether a patient can live self-sufficiently (release from an institution), risk that patients will experience frequent mental disorder episodes, and so on.

The present invention may also be used to evaluate risk that individuals pose while under the supervision of adult corrections, such as those in a special release program or on parole. These risk areas include, but are not limited to, risk for returning to criminal behavior, abusive and/or violent behavior, returning to prison, and/or abusing drugs and/or alcohol. Using the present invention, prisoners under consideration for parole may be assessed for risk of returning to criminal behavior after their release.

The dynamic risk assessment, risk monitor, and caseload management methods and systems described herein may be used to evaluate an individual at any stage an individual assumes in a system (e.g., a juvenile justice system that oversees and/or assesses an child possibly at risk). Stages may be of any number including one. A system having a plurality of stages may include movement by an individual from one stage to the other in either a progressive or regressive manner. For example, a juvenile justice system may have an initial “intake” stage in which an individual is referred from the courts or the police. In a child welfare system, an individual may be placed into the intake stage from a referral from a telephone hotline call. At each stage, an individual may be assessed using the present invention to determine risk status and assist in decisions, such as whether movement is needed between stages, whether the individual should be removed from the system and/or moved to another appropriate system. An individual may progress from the intake stage to a higher level, such as a more comprehensive intake stage where a more detailed analysis may be performed. Other possible stages include an intervention stage, a stage where decisions are made to forcibly change risk status, or an aftercare stage to check on status after intervention. The present application may be applied to assess risk, foster communication, track progression and financial information, and help with making stage-to-stage movement decisions.

To perform risk assessment in the present invention, system variables are first defined for each risk category, such as the categories described above, for example. A value is determined for each system variable from information gathered in an initial interview or investigation with the individual being assessed for risk and other individuals associated with the primary client's environment, behavior, physical condition, personal relationships and/or mental state of being. The individual being assessed for risk and other individuals associated with the individual being assessed for risk hereinafter will be respectively referred to as the “primary client” and “secondary clients.” A secondary client charged with monitoring risk will hereinafter be referred to as a “worker.” Variable values are then processed by a computer risk assessment application in the system to determine a composite risk score that indicates a level of risk present at the time the values were determined. Data resulting from processed variable values used in risk computation is stored in the computer memory, or a database. This data may be updated by primary and secondary clients through access to the computer in a controlled network environment, and thus allow for dynamic risk evaluations that closely resemble “real-time” assessments.

A set of system input variables may be customized for any particular area of risk, such as those described in Table I, below, for child abuse risk assessment. However, individuals frequently may be at risk in more than one type of risk category, such as a combination of risks including drug abuse and criminal behavior. To assess multiple categories of risk for these individuals, information pertaining to several risk categories may be gathered during an interview or investigation period. Since many system input variables are common to different risk areas, input for each category of risk assessment may include a set of these common variables. Sets of uncommon system input variables respectively corresponding to different risk categories may be combined with the common input set to form input into a program application designed for assessing a specific risk. This may be repeated or performed in a parallel or multi-task fashion by the system computer until a risk score is produced for each of the multiple risk categories. Instead of a separate risk analysis, assessment of multiple risks, such as with drug abusing criminals, may be performed using a system application that considers a broad base of system input variables simultaneously. In the drug abusing criminal case, since it is generally known that risk belonging to the drug abuse risk category influences risk for criminal behavior, a risk assessment application for the single risk category “risk of returning to criminal behavior” may include variables describing a broad base of information that includes variables that would also be used for risk assessing drug abuse alone. However, common variables used to evaluate different risk categories may be weighted differently when assessing risk for each category.

It is to be understood that the present invention may be used for any type of detrimental risk individuals face in society as long as risk can be characterized for input into a computer risk assessment application, such as a fuzzy logic system, an artificial neural network, an adaptive fuzzy logic system (described below), or any other artificial intelligence system known to those skilled in the art.

Risk assessment is a complex process where decisions leading to a risk assessment score are made based on weighting variables defined by experts in the field. A composite risk score is reached by combining weighted contributions of these variables. Whether a variable is particularly relevant, or should be minimized, is usually left to the judgement of an expert in the particular field of risk being assessed. Additionally, variables under consideration when assessing risk, by their nature, are often imprecise or uncertain in the classical first order logic and classical probability theory sense. Because the number of relevant variables and determination of particular weights assigned to them present a formidable task for a system designer, known systems often produce scores that fail to adequately represent risk. Classical logic deals with the bivalent, i.e., the “black and white,” the absolute True or False, or the “0” or “1” universe, and reasoning systems developed along classical lines fall short of representing common sense knowledge often used in decisions made by systems having imprecise or uncertain inputs.

### FUZZY LOGIC EXPERT SYSTEMS

Fuzzy logic developed out of a need to represent, mathematically, uncertainty and vagueness, and to provide formalized tools for dealing with the imprecision intrinsic to many real world problems. Fuzzy logic makes use of fuzzy sets and fuzzy relational equations. Unlike classical logic, wherein a subset A of elements in a set X can be mapped into either True and False represented by the set {0,1 } (where “0” represents non-membership, false, and “1” represents membership, true), a fuzzy set can include a continuum of values representing a degree to which an element belongs, or is a member of the set X. In fuzzy theory, linguistic quantifiers such as “never,” “sometimes” and “always” are used to relate elements of different fuzzy sets. Once fuzzy sets are established over so-called “discourses of universe,” fuzzy rules are defined to relate fuzzy sets. For example, universe of discourses X and Y can respectively represent speed and stopping distance. Ranges of the universe of discourse can include several subsets, such as {X: slow, medium, fast} and {Y: long, short}. Fuzzy rules relating fuzzy subsets of X and Y could be:

1) IF speed is high,

THEN stopping distance is long; or

2) IF speed is low,

THEN stopping distance is short.

System experts define such fuzzy “IF-THEN” rules using common sense, intuition, observation, modeling and/or experience to compile a rule base for a fuzzy logic “expert system.” Fuzzy expert systems generally incorporate several rules for the rule base that describe expert knowledge that play off one another. The system will output a single fuzzy set that is “defuzzified” into a single useful number. In the context of the present invention, input variables representing risk factors are first “fuzzified” to create input fuzzy sets. System fuzzy rules are then applied to operate on input fuzzy sets and produce a fuzzy output. The fuzzy logic system output is then defuzzified into a composite risk assessment score. The system structure to perform these steps is described in more detail below.

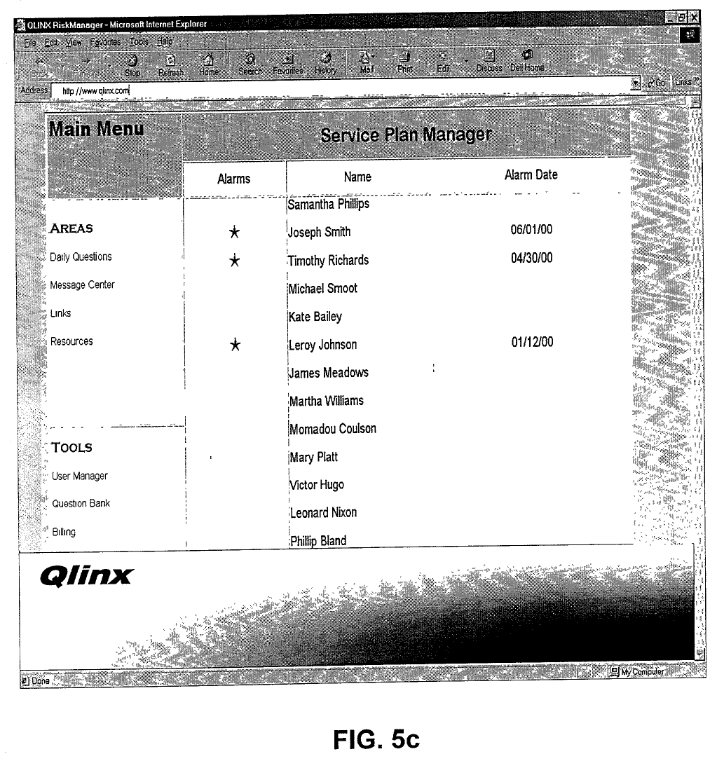

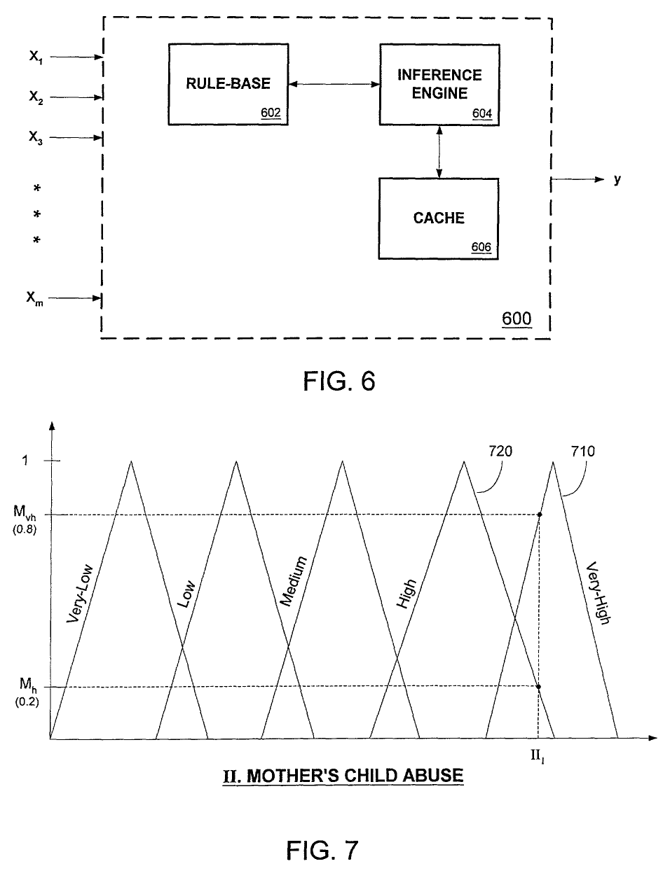

As shown in FIG. 6, a fuzzy logic expert system 600 may comprise three functional and interacting components, such as a rule-base 602, an inference engine 604, and a cache 606. Rule-base 602 is a collection of IF-THEN rules defined by experts in the field. The rules direct the fuzzy logic expert system's manipulation of measured input data x₁, x_{2, x}₃, . . . , xₘ. Cache 606 provides a dynamic working memory for the fuzzy logic expert system. Inference engine 604 applies incoming data x₁, x₂, x₃, . . . , xₘ, to the rules within the rule-base 602 and updates the state of the cache 606.

Measured input values, x₁, x₂, x₃, . . . , xₘ, that are input into the system may be obtained from a variety of sources, such as an initial primary and/or secondary client interview or investigation, and/or submission of information through network access of the system by primary or secondary clients. These input values must first be related to linguistic variables (fuzzy variables) of rules in rule base 602 through membership in one or more fuzzy set. Curves that relate a measured value to a linguistic variable, known as “membership functions,” can take a variety of forms, such as triangular, rhomboid, Gaussian or trapezoidal shapes, and are usually normalized to the range [0,1]. However, the present invention is not limited these shapes and to a [0,1] normalized range, and the membership function may take on other shapes and normalized ranges as will be known to these skilled in the art.

FIG. 7 shows a possible set of triangular shaped membership functions relating fuzzy variables to a measured input variable x=II₁ that pertains to “II. Mother's child abuse history” (see Table I). Measurement II₁ may be determined from information regarding the mother's experiences and records of being abused as a child. For example, the value may be determined based on a total number of abuse incidences, severity of abuse, and frequency of abuse. As shown in FIG. 7, measured value II₁ has a membership of mᵥₕ in the value “very-high” 710 and a membership mₕ in the value “high” 720. A degree to which a rule R^{S} (where s is one of n rules in rule-base 602) fires depends on a measured value's degree of membership in a fuzzy set, known as a membership value and defined by a membership function. For example, for the input value II₁ shown in FIG. 7, a rule R¹ pertaining to fuzzy variable “very-high” may fire at 80%, and a rule R² pertaining to fuzzy variable “high” may also fire, but only at 20%. Fuzzy rule R^{S} is an IF-THEN rule where antecedent components of the rule are the linguistic variables, and may take the general form:

R^{S}: If x₁ is A₁^{S}, x₂ is A₂^{S}, . . . , xₘ is Aₘ^{S}

Then y^{S}=c₀^{S}+c₁^{S}x₁+c₂^{S}x₂+ . . . +cₘ^{S}xₘ

where R^{S} indicates the s^{th} rule; xⱼ, an input value; Aⱼ^{S}, a fuzzy variable; y^{S}, an output from the s^{th} rule; and c^{S}, a THEN part parameter.

Cache 606 functions as the dynamic working memory of the fuzzy logic expert system. The current state of any active rule is stored in the cache along with information about the validity of the rule's antecedents (e.g., the measured abuse of the mother). Inference engine 604 is the part of the system that draws conclusions by manipulating rules from rule-base 602 and facts from cache 606 and updates the current values in the cache during processing. Inference engine 604 manipulates collections of fuzzy rules (also referred to as inference rules) according to a “compositional rule of inference.” A compositional rule of inference is a procedure that describes how to combine different linguistic (fuzzy) variables.

In the present invention, an output of one rule may serve as the input antecedent to another rule, and so on, in a feedforward fashion. In this case, the modification of one antecedent almost always involves a recalculation of several other antecedents, an updating of these antecedent states in the cache 606, and a reapplication of the rules in rule-base 602 to the updated antecedents.

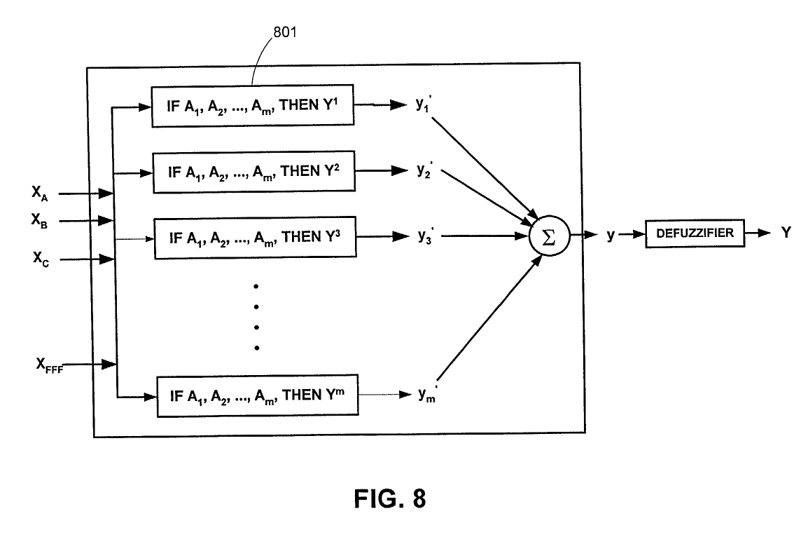

FIG. 8 figuratively shows how rule outputs y^{S} are summed to produce a composite risk score Y. (While FIG. 8 shows each rule 801 as having every fuzzy variable “A,” it is to be understood that this is for conceptual purposes only. Each rule may have different combinations of fuzzy variables and also may have other logical operators, such as OR, AND, NOT, etc.) Input data x_{A}, x_{B}, x_{C}, . . . , x_{FFF} from various measured input variables, such as those in Table I for child abuse risk assessment, fires their corresponding “A” part of each rule in the rule-base 602 to a degree the depends on the membership value of the input to produce outputs y₁′, y₂′, . . . , yₘ′. These outputs are then summed to arrive at inference output y. Because the combination of a number of linguistic variables is itself a linguistic variable, application of the compositional rule of inference needs to be followed by a technique to defuzzify its result to generate a single output value Y that can, for example, be indicative of a composite risk score. Defuzzification techniques such as center-of-area/gravity, center-of-sums, center of largest area, first-of-maxima, middle-of-maxima, max-criterion, height defuzzification, or others known to those skilled in the art may be used to produce a useful risk output score in the present invention.

### ARTIFICIAL NEURAL NETWORKS

Another known method for modeling complex systems uses artificial neural networks (ANNs). ANNs mimic human learning instead of using fixed, preprogrammed approximate reasoning or rules, such as with fuzzy logic systems. An ANN is a collection of neuron-like units, or simply neurons or nodes, interconnected with “synapses” that can acquire, store and utilize experimental knowledge. ANNs can run on software or hardware. Unlike conventional heuristic fuzzy systems, ANNs have the ability to learn from experience and globally estimate input-output functions in a parallel-distribution framework. ANNs can automatically adjust their weights to optimize their behavior as pattern recognizers, predictors, decision-makers, system controllers, etc. Adaptivity allows the ANN to perform well even when the environment varies over time.

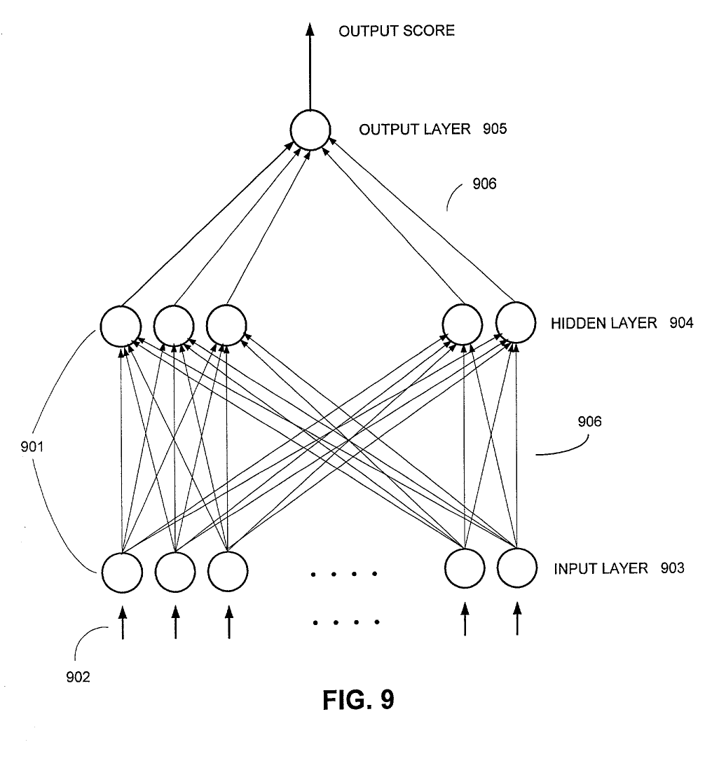

FIG. 9 is an illustration of a typical multi-layer feed-forward ANN. Each neuron 901 is characterized by an activity level representing the state of polarization for the neuron, an output value representing the firing rate of the neuron, a set of input connections 902 representing synapses on the cell and its dendrites, a bias value representing an internal resting level of the neuron, and a set of output connections representing a neuron's axonal projections. Each of these aspects of the neuron is represented mathematically by real numbers. Thus, each connection has an associated weight (synaptic strength) that determines the effect of the incoming input on the activation level of the neuron. The weights may be positive or negative. The multi-layer ANN structure includes an input layer of processing units 903, one or more hidden layers 904 of processing units, and an output layer of one or more processing units 905.

Each neuron receives multiple input values that are processed into outputs in a feedforward manner, as illustrated by arrows 905 in FIG. 9. The output value of each neuron is calculated using a mathematical equation, known in the art as an activation function or transfer function that specifies the relationship between input data values. Neuron output values at lower levels are provided as inputs to neurons in higher levels. The highest system level produces a final system output. In the context of the present invention, risk factor variables are input into the ANN as neural inputs, and the ANN output is converted to a useful number representing a composite risk score.

While conventional ANNs provide advantages of adaptability and fast processing speed, the “rules” underlying such a system are difficult to uncover. This “black box” nature of known ANNs provides little or no insight into reasons why outputs appear as they do. ANNs also need training to acquire rules governing desired system behavior, and ANN training using known input-output data and error backpropagation algorithms is a relatively slow process. It is also not possible to integrate special information about a problem into an ANN to simplify training.

On the other hand, fuzzy logic systems allow users to view its rules and thus permit fine-tuning of its rule set to improve system performance. However, a fuzzy system rule, i.e., knowledge, is not automatically discovered as in ANNs. Also, fuzzy set membership function fine tuning operations require laborious methods that resemble more of an art form than an exact science.

### NEURO-FUZZY SYSTEMS

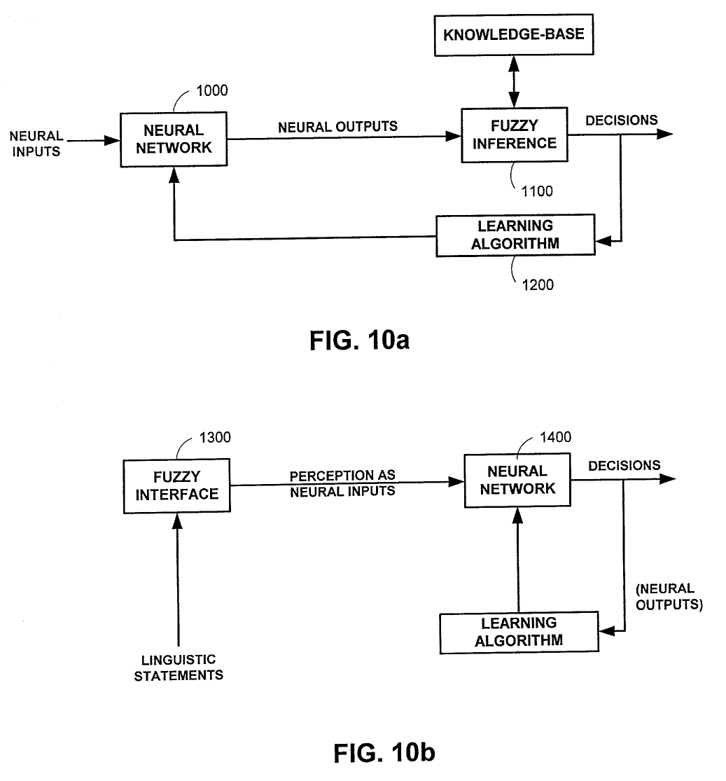

As an alternative to using pure fuzzy logic or ANN based risk assessment applications, the risk assessment application of the present invention may be formed from a hybrid of fuzzy logic and neural networks, or combination of the two, and thus may have the advantages of both fuzzy logic systems and ANN systems. Several cooperative approaches combining fuzzy logic systems with neural networks have recently gained popularity. These systems generally have the advantages of both fuzzy and ANN systems, i.e., they have the ability to learn and adapt, and knowledge can be discovered from the system. These resulting systems are known as adaptive fuzzy, neural fuzzy, fuzzy neural, neuro-fuzzy, or fuzzy-neuro networks or systems. Some adaptive fuzzy logic systems use neural networks to fine tune fuzzy set membership functions. FIG. 10a schematically illustrates these system types. As shown in FIG. 10a, by using neural network learning algorithm 1200, a neural network 1000 fine tunes membership functions of inputs into fuzzy inference engine 1100, and thus automates the laborious process used to quantitatively define linguistic labels in fuzzy logic systems. In other system types, shown schematically in FIG. 10b, fuzzy interface 1300 provides an input vector to a multi-layer neural network 1400 in response to linguistic statements. Neural network 1400 may be adapted (trained) to yield desired command outputs or decisions. Others use a combination of self-organizing map techniques that use neural networks to cluster experimental (known) input-output data. Each cluster corresponds to one fuzzy principle rule. Consequently, each fuzzy rule may be discovered from the number of resulting clusters by mapping known input-output. Learning vector quantization techniques then fine-tune the clusters to initialize rule learning (by a back propagation technique) with high accuracy. In the context of the present invention, any one of these neuro-fuzzy systems, and the myriad of others known to those skilled in the art, capable of adaptively assessing risk variables can be used.

Several variables must first be evaluated for system input in the risk assessment system of the present invention. The Table shows an exemplary set of adaptive fuzzy system input variables appropriate for assessing a child's risk of physical abuse. While some variables are fixed at any particular instant in time such as age, many variables such as “mental health” are difficult to define precisely, and thus may constitute fuzzy sets over universe of discourses. The system converts responses to queries posed by the system to the client into fuzzy or neural inputs that can be used in the risk assessment application of the present invention.

TABLE
Input Variables for a Child Abuse Risk Assessment
(exemplary subset of system algorithm)

| | |
|---|---|
| A. | Age of mother |
| B. | Age of father |
| C. | Age of reported child |
| D. | Ages and number of siblings living in same household |
| E. | Age of live-in boyfriend |
| F. | Age of live-in girlfriend |
| G. | Age of live-in Grandparent(s) |
| H. | Household income |
| I. | TANF status |
| J. | Gender of Reported Child |
| K. | Gender of Identified/Reported perpetrator |
| L. | Employment status of Father |
| M. | Employment status of Mother |
| N. | Employment status of live-in Boyfriend |
| O. | Employment status of live-in Girlfriend |
| P. | Access to child care |
| Q. | Father's level of education |
| R. | Mother's level of education |
| S. | Reported child's performance in school |
| T. | Number and/or clustering of sick days at school |
| U. | Number of Parent/Teacher conferences parent attended |
| V. | Relevant criminal history of Mother |
| W. | Relevant criminal history of Father |
| X. | Relevant criminal history of live-in Boyfriend |
| Y. | Relevant criminal history of live-in Girlfriend |
| Z. | Mental health of Mother |
| AA. | Mental health of Father |
| BB. | Mental health of live-in Boyfriend |
| CC. | Mental health of live-in Girlfriend |
| DD. | Previous level(s) of abuse toward reported child |
| EE. | Number of past reports filed for reported child, and reporter's |
| | relationship |
| FF. | Relationship of reporter to reported child/family |
| GG. | Previous level(s) of abuse toward reported child's siblings |
| HH. | Number of past reports filed for reported child's siblings |
| II. | Mother's child abuse history |
| JJ. | Father's child abuse history |
| KK. | Live-in Boyfriend's child abuse history |
| LL. | Live-in Girlfriend's child abuse history |
| MM. | Number of years living in neighborhood |
| NN. | Number of clubs/organizations/associations reported child's |
| | caretakers belong to |
| OO. | Availability of neighborhood/community-based supports |
| PP. | Drug and alcohol history of Mother |
| QQ. | Drug and alcohol history of Father |
| RR. | Drug and alcohol history of live-in Boyfriend |
| SS. | Drug and alcohol history of live-in Girlfriend |
| TT. | Number of domestic violence (intimate partner violence) |
| | incidences |
| UU. | Level of domestic violence incidences |
| VV. | Severity of abuse being reported |
| WW. | Severity of reported child's physical handicap |
| XX. | Severity of reported child's mental handicap |
| YY. | Identified/reported perpetrator's access to child |
| ZZ. | Condition of home |
| AAA. | Family's stage of change |
| BBB. | Address of reported child's home |
| CCC. | Emergency medical examination results |
| DDD. | Unexplained burns, lumps, and/or bruises on body |
| EEE. | Parent's responsiveness when reported child needed medical |
| | attention |
| FFF. | Level/Intensity/Philosophy of child welfare services offered |

System input can arrive from a variety of sources. An initial phone report and/or interview with a primary and/or with secondary clients may be used to matriculate a primary client in the system of the present invention. Secondary clients may include the primary client's parents, individuals living with the primary client, friends of the primary client, a teacher, an employer, the primary client's doctor and/or health care provider, protective service agency employees who oversee a child, a counselor, a law enforcement official, a parole official, a caseworker, an investigator, and any other involved providers or agencies who may provide relevant information in assessing a primary client's risk. At this time, initial queries are used to establish system variables from which a risk assessment application calculates an initial risk assessment score. An overall goal is then established for lowering the primary client's risk exposure that is based on the risk score and information gathered from secondary clients. Subsequent to the initial report, regular checkpoints scheduled by investigators and/or reporters at predetermined intervals update the primary client's risk assessment. Preferably, the system of the present invention also allows input into the risk assessment application from the primary client and secondary clients on a continuous basis to provide more continuous-like updating of risk assessment.

Preferably, the risk assessment application is accessible by, or part of an overall system application that performs risk assessment, monitors risk, and assists workers in the field in managing primary client risk, thus forming a risk assessment, risk monitor, and case management system. This system application may be implemented by software on a computer. The risk assessment application of the present invention may be implemented with a software application or hardware that resides in the computer. Other data processing, data storage, and data retrieval of the system may be performed using the system software stored in the computer. The computer may be a server connected to a network with other devices capable running an Internet browser or other software that can be used to send, receive and display Web page information. These devices may include personal computers, portable computer devices, such as handheld or laptop computers, electronic paper, video monitors, audio systems, and wireless devices, such as wireless phones and PDA (Personal Data Assistant) devices. Other devices known to those skilled in the art are intended to be in the scope of the present invention.

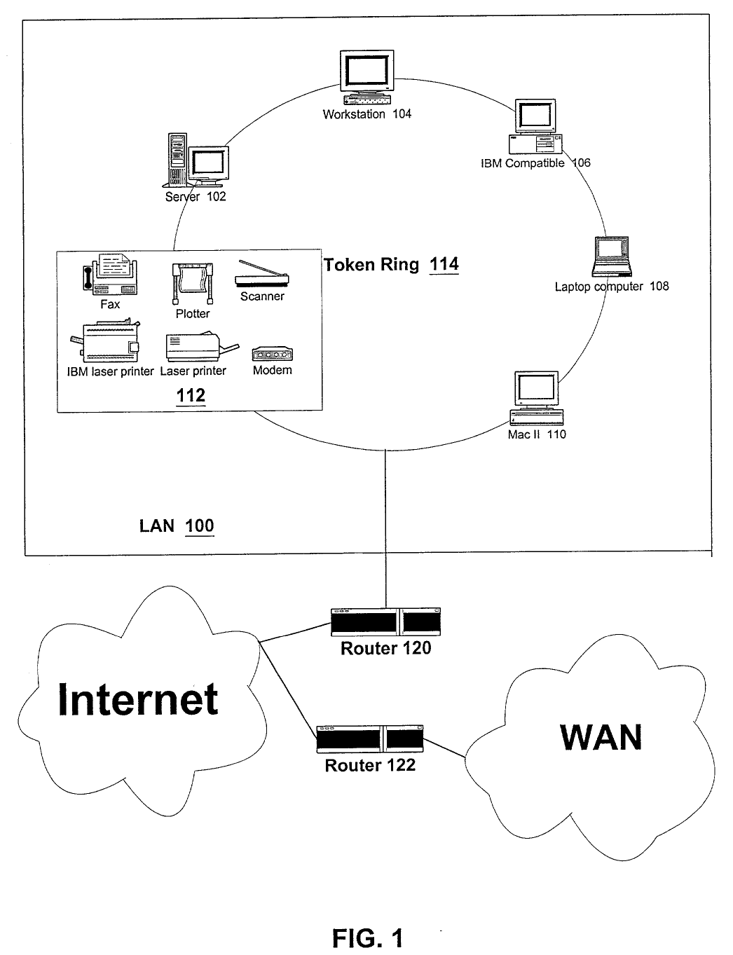

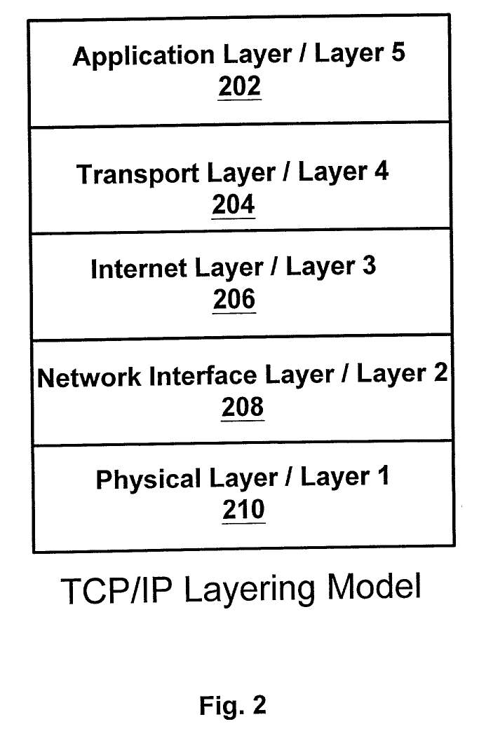

The server computer (server) and other components of the risk assessment, risk monitor, and case management system of the present invention may be connected via a network utilizing Transmission Control Protocol/Internet Protocol (TCP/IP). FIGS. 1 and 2 describe a typical network environment that may be used by the system of the present invention.

FIG. 1 is an example of a local area network (LAN) 100. LAN 100 comprises a server 102, four computer systems 104-110, and peripherals, such as printers and other devices 112, which may be shared by components on LAN 100. Computer systems 104-110 may serve as clients for server 102 and/or as clients and/or servers for each other and/or for other components connected to LAN 100. Components on LAN 100 are preferably connected together by cable media, for example copper or fiber-optic cable and the network topology may be a token ring topology 114. It should be apparent to those of ordinary skill in the art that other media, for example, wireless media, such as optical and radio frequency, may also connect LAN 100 components. It should also be apparent that other network topologies, such as Ethernet, may be used.

Data may be transferred between components on LAN 100 in packets, i.e., blocks of data that are individually transmitted over LAN 100. Routers 120, 122 create an expanded network by connecting LAN 100 to other computer networks, such as the Internet, other LANs or Wide Area Networks (WAN). Routers are hardware devices that may include a conventional processor, memory, and separate I/O interface for each network to which it connects. Hence, components on the expanded network may share information and services with each other. In order for communications to occur between components of physically connected networks, all components on the expanded network and the routers that connect them must adhere to a standard protocol. Computer networks connected to the Internet and to other networks typically use the TCP/IP Layering Model Protocol. It is to be understood that other Internet working protocols may be used with the present invention.

As illustrated in FIG. 2, TCP/IP Layering Model comprises an application layer (Layer 5) 202, a transport layer (Layer 4) 204, an Internet layer (Layer 3) 206, a network interface layer (Layer 2) 208, and a physical layer (Layer 1) 210. Application layer protocols 202 specify how each software application connected to the network uses the network. Transport layer protocols 204 specify how to ensure reliable transfer among complex protocols. Internet layer protocols 206 specify the format of packets sent across the network as well as mechanisms used to forward packets from a computer through one or more routers to a final destination. Network interface layer protocols 208 specify how to organize data into frames and how a computer transmits frames over the network. Physical layer protocols 210 correspond to the basic network hardware. By using TCP/IP Layering model protocols, any component connected to the network can communicate with any other component connected directly or indirectly to one of the attached networks.

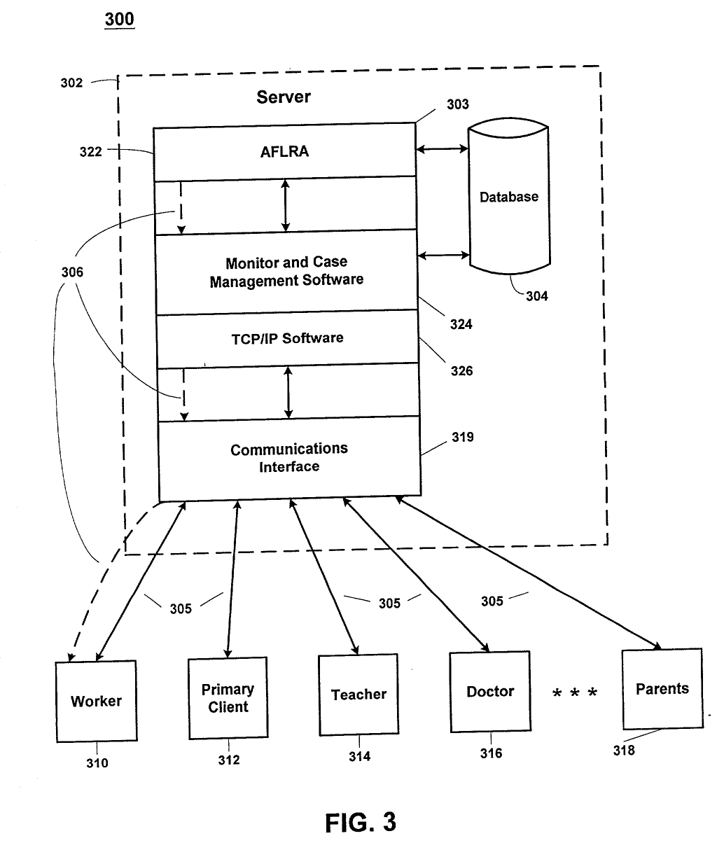

As shown in FIG. 3, a server 302 utilizing the risk assessment software or hardware of the present invention, exemplary shown as an Adaptive Fuzzy Logic Risk Assessment (AFLRA) application 322, can be accessed by a primary or secondary client through a Web page generated on one of the devices 310-318. The server 302 allows a client a privileged level of access to information stored in the computer memory. Access to server 302 includes input from the client and interaction with the client. The primary client may have a specified level of access. Levels of access for secondary clients may depend on the relationship the secondary client has with the primary client.

For example, server 302 includes a database 304 storing a question bank and client data. When server 302 senses a primary or secondary client computer 310-318 attempting access, it prompts the client's computer for a password or other means known to those skilled in the art to allow the client's privileged level of server access. After verification, the server sends a Web page to the client's computer that contains information, the content of which depends on a client's privilege level assigned and stored in database 304. The content may include a query that is used by the server to ultimately update risk assessment.

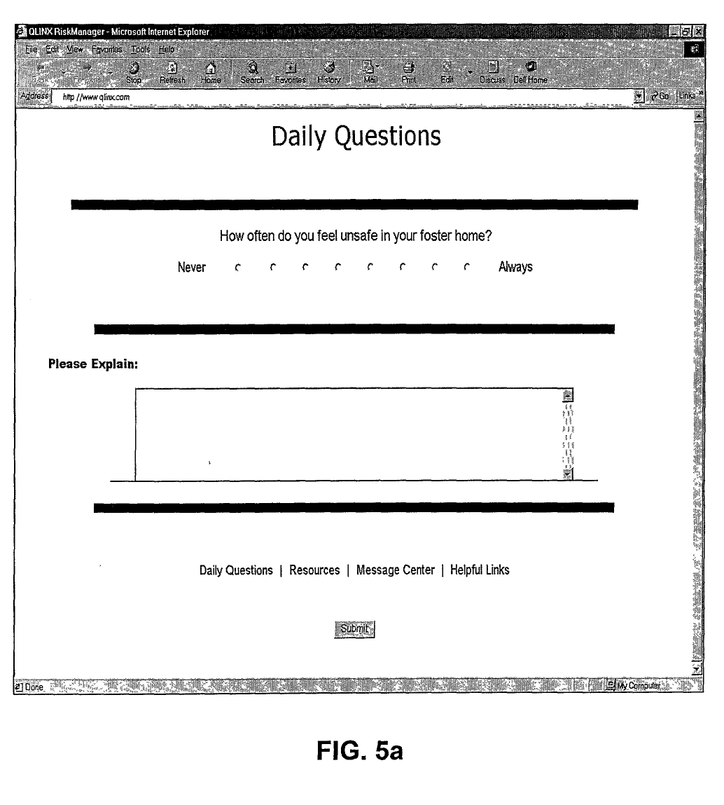

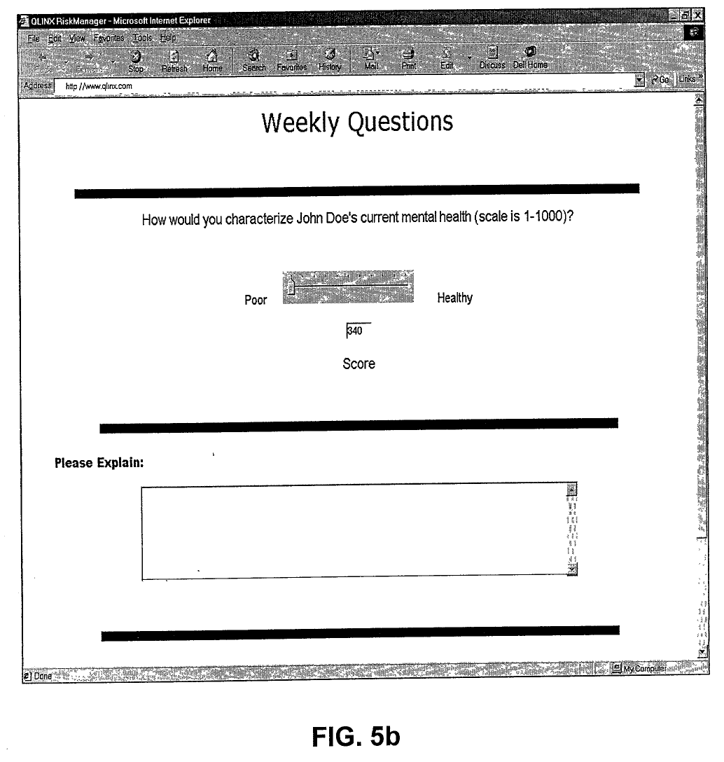

Scheduled checkpoints for updating system input variables may include periodic mandatory client access to the server. Scheduled mandatory access can be preprogrammed into the system software, whereby through a Web page the system prompts the client with a query set. Typical Web pages for various risk categories are illustrated in FIGS. 5a-5c. FIG. 5a shows a query 502 for a primary client being monitored for risk of abuse where the primary client chooses among discrete values 504. A more “continuous” scale for query response is shown in FIG. 5b. Here, query 502 is downloaded to a secondary client, such as a health care provider. The secondary client moves pointer 506 using a mouse, keyboard, or other means known to those skilled in the art, to a position representing a measured value. In each of the exemplary queries, a client selects appropriate responses to the query and then submits them to the server. This procedure may be repeated until all query responses are received by the server's system application.

Client responses are stored in memory areas of database 304 that can be accessed by the risk assessment application of the present invention, and, if necessary, converted to useful risk assessment input before or after storage. The system may run a primary client risk assessment at this time to provide updated risk assessment scores as data from query sets arrive. However, it is to be understood that primary client risk score updates may be performed at any desired interval.

The risk assessment application of the system can be programmed to generate a signal alerting worker personnel when change occurs in any primary client risk score. The purpose of the signal is to assist workers in caseload management. The signal can be in the form of indicia such as a flag or exclamation point next to a primary client name or identifier within a Web page frame displaying a case docket list. Other signaling methods and/or combinations of methods can be used, such as a sorting program that lists client in an order of priority based on risk score. An audio message may be generated by the risk assessment application and provided to the voice mail of a worker to alert the worker of an alarm. As another example, a worker accessing server 302 may be prompted with a Web page displaying information regarding primary clients having unacceptable risk. Names or identifiers could be linked with URLs in a manner where their selection by mouse or other method known to those skilled in the art directs the client's browser to display further documentation at the server URL address. This server URL can be updated with information from past and current client queries to provide the worker with useful information regarding reasons why risk has changed. FIG. 5c shows an exemplary Web page accessible by a worker where a listing of primary clients 508 includes a flag 509 next to each primary client having a high-risk assessment. Each listing 508 may comprise a URL, which when selected, causes server 302 to download and display on the worker computer 310 the selected primary client's detailed information stored in database 304.

Another feature of the present invention is directed to providing a primary or secondary client with helpful resources generated by the system, or selected by workers and provided to the client through a communication application within the system. Resources relevant to a particular query response or group of responses may be provided to the client's computer from the system database through a Web page generated by server 302. As an example, the primary client's father responds to a query regarding his employment status that changes his status to reflect unemployment. After he finishes his query set, the server system application can generate a list of employment opportunities available within his locality, and/or appropriate for his skill/education level. Query responses also could trigger list generations of other types of resources, such as anger management, Alcoholics Anonymous, drug counseling centers, job training, etc. The purpose of generating helpful resources is to provide almost immediate assistance to the client at the time input variables change and adversely affect risk score. General resources such as community events, news, and other information helpful to the client can be made available from a server Web page on an ongoing basis, and thus provide incentive for accessing the system of the present invention. The system may then become a broker for needed services based in the specific risk levels that are present within each client's milieu.

### System Components

FIG. 3 illustrates the components of inventive dynamic risk assessment, risk monitor, and case management system 300 that uses the Internet or other networks to compute a primary client's composite risk score monitor and update the client's risk assessment, and assist the worker in managing a docket of primary clients. System 300 includes server 302 and client computers 310-318. These components are preferably connected through a TCP/IP network, although other networks are known to those skilled in the art and are intended to be within the scope of the present invention.

As shown in FIG. 3, server 302 includes computer 303 and database 304. Server 302 runs several software components. These software components may include fuzzy logic, ANN or AFLRA software 322, monitoring and case management software (system software) 324, and TCP/IP networking software 326. It is to be understood that other software or hardware components can be included in server 302. These applications may include a messaging application allowing client-client or worker-client communication in a less structured manner, and other administrative applications such as documentation, billing, and treatment. It also is to be understood from the present invention that any applications run by server 302 may be implemented as a single application, or parsed into any number of applications that are accessed as needed by a controlling program.

Client computers 310-318 may run browser applications such as Microsoft Internet Explorer™ or Netscape Navigator™ to access server 302. The browser may instead be a custom browser or any type of browser that can be used to display a page downloaded from the Internet. The browser is capable of processing commands that may be contained in a downloaded HTML or XML document. Arrows 305 conceptually illustrate the connections between computers 310-318 and server 302. It is to be understood that server-client connection may take any of the forms discussed above, such as through optical, wire, and/or wireless media, for example.

System software 324 processes data retrieved from the network through TCP/IP software 326. When a client computer browser application requests server access, system software 324 generates Web page data that is processed by the TCP/IP software and is downloaded to the client's computer. Server 302 and primary and secondary client computers 310-318 interact by exchanging information generated by system software 324 and primary and secondary clients. Data retrieved from client computers may be stored in database 304 and/or processed for input into the fuzzy logic, ANN, or AFLRA application. Output from the risk assessment application can also be stored in database 304 either directly from the risk assessment application, or through system software 324. Data from the client computer may instruct system software 324 to retrieve data stored in the database, such as a query set or primary client data. All of these steps may occur in real-time to continuously inform the caseworker in his/her daily work/interventions.

### System Operation

Server 302 uses TCP/IP software to identify primary and secondary client computers 310-318 and communicate with them, as well as to process data communicated from the primary and secondary clients by monitoring the primary client factors using query responses generated by server 302 or other means described below. Risk assessment scores may be continuously updated through client access to the system. When an AFLRA or ANN application is used for risk assessment, it has the ability to learn and adapt from input patterns processed as input from system query responses, backpropagation techniques, expert(s) rule generation, and/or other methods known to those skilled in the art. Server 302 stores updated risk scores in database 304 in areas representing the primary client. When scores exceed a predetermined acceptable value, the system software 324 further generates data markers within these database areas that are indicative that a primary client is at unacceptable risk. A worker computer 310 accessing server 302 prompts the system to execute system software 324 to process primary client data stored and displays the primary client data. The markers stored in the database cause software program 324 to “flag” the data of primary clients displayed through a Web page downloaded to the worker computer 310.

When primary or secondary clients access server 302 and are identified by the server 302, system software 324 then executes a download Web page containing a query set, and if appropriate, helpful resource information. Generally, query sets are determined based on client ID, and may be generated automatically and dynamically by particular response sets by monitor and case management software 324 by retrieval of query sets stored within the database. Queries also may be generated by a worker entering a query set deemed appropriate into the client database space or by storing a pointer in the database space that points to a query set stored in the database. A query set may be chosen based on an overall goal assigned the primary client and stored in the database after the first interview and initial risk assessment. The goal can be adjusted as needed during the entire time the primary client is in the system.

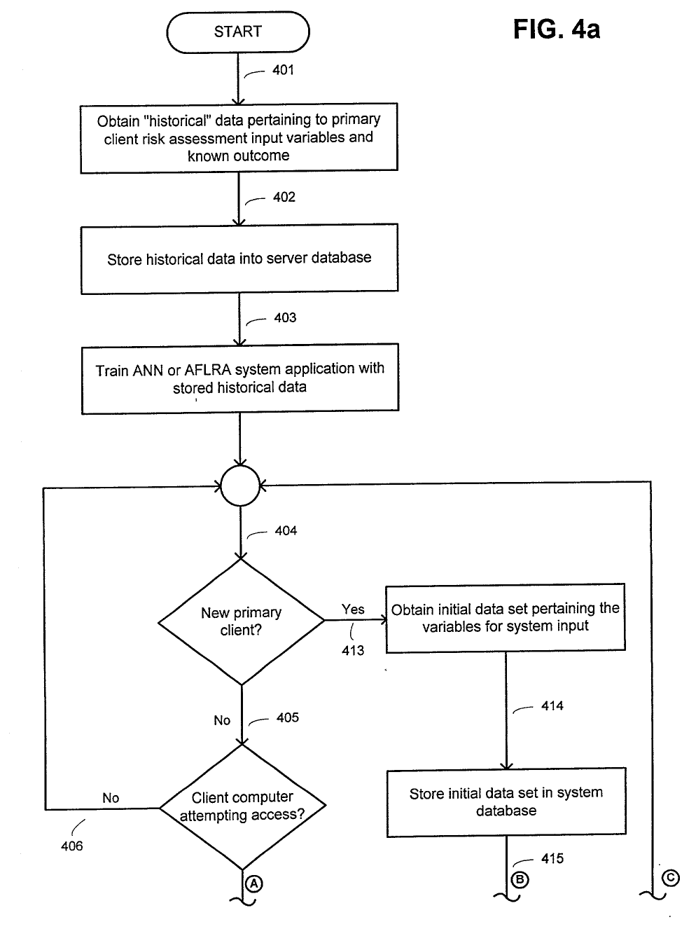

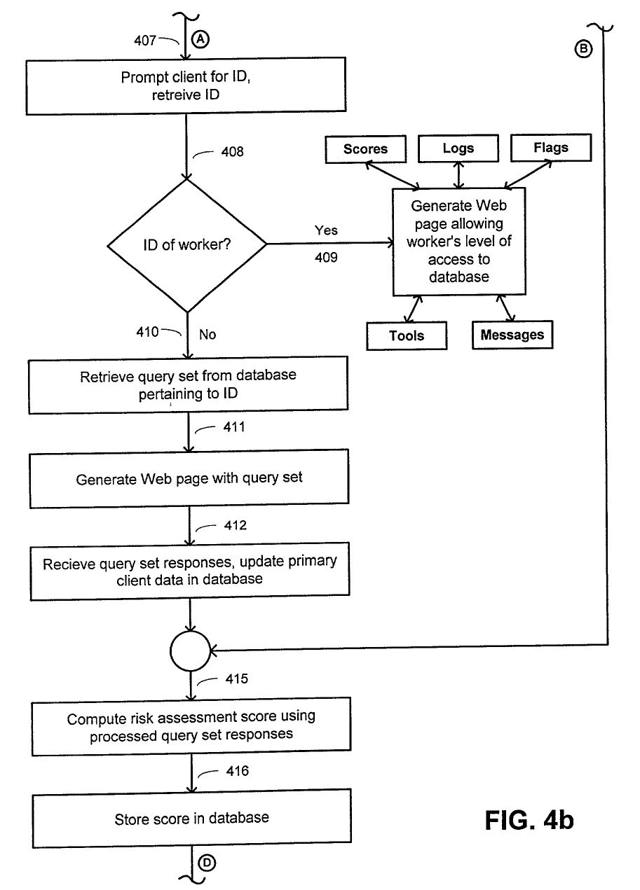

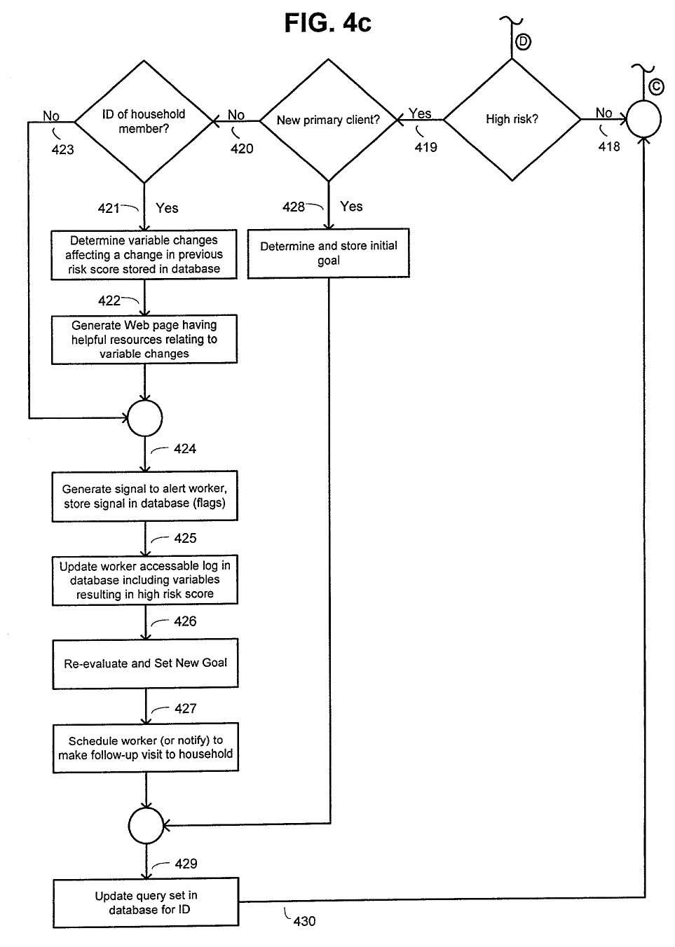

FIGS. 4(a) to 4(c) illustrate an exemplary process flow for practicing the inventive risk assessment, risk monitor, and case management system. This process continuously monitors and assesses risk associated with each primary client in the system. Data acquired, stored, and processed in the system is also used to document and manage primary client risk.

Process 401 represents a step that may be included to initiate a risk assessment application when using ANN or AFLRA based applications. Input-output data sets of known risk assessment input and expected output are first obtained. This “historical” data is then stored in database 304 during process 402. The historical data set is used to train the ANN or AFLRA software in process 403 using error backpropagation or other training algorithms known to those skilled in the art. Of course, it is to be understood that steps 401-403 are not always necessary if a fuzzy logic expert system is used alone as the risk assessment application in the present invention.

After the ANN or AFLRA application is sufficiently trained, system 300 is activated to allow network access. Thereafter system 300 never shuts down. Decision blocks 404, 405 and path 406 together represent the process where server 302 is in standby mode where it continually checks for clients attempting access to the system. A worker who wishes to enter a new primary client in the system may request access to the server. At this time, the system software 324 creates a new primary client log space within database 304. This is represented by process 413 in which new primary client data is gathered and is entered into system database 304 in process 414. Data may be entered using a peripheral device (not shown) hardwired to the system, by uploading a Web page to server 302 from the worker through TCP/IP software, by telephonic land lines, through airwaves, and/or any other means known to those skilled in the art. New primary client data may also include data from secondary clients. Preferably, new primary client data may be entered in an ongoing basis after activation of system 300.

Data pertaining to measured input variables are determined from query sets of an initial interview between a worker, a primary client, and/or other secondary clients. System software 324 pre-processes the query data into proper form for the fuzzy or neural network input of the risk assessment application. Alternatively, the fuzzy logic, ANN or AFLRA software 322, or a separate application feeding pre-processed input into the software may process query data. As shown in FIG. 4b, process 415 then performs an initial risk assessment of the primary client and the resulting risk score is then stored into database 304 in process 416.

Decision block 417 represents a process where an initially assessed risk score is compared to a maximum acceptable value. If the assessed risk score does not exceed the acceptable value, no unacceptable risk is present and the system returns to standby mode (process 404). If the initial score is indicative of unacceptable risk (high risk), process 428 is performed to determine and store an initial “goal.” The initial goal may be determined by a worker or generated automatically by system software 324. For example, a goal for a child who enters into foster care, and who is under assessment for abuse, may include returning the child to his or her biological parents in a safe environment. A mental health outpatient or ex-prisoner's goal may include employment. A drug abuser's goal simply may be to regularly attend AA and/or NA meetings. A new query set is then updated in the database for the new primary client in process 429, and the system returns to standby mode (process 404).

When primary or secondary clients (including a worker) who already matriculated into database 304 attempt access, the system software 324 generates a prompt in process 407 for identification (ID) and/or password input. Decision block 408 determines whether the ID corresponds to a worker. If server 302 recognizes the ID as that of a worker, process 409 is performed to allow the worker a special level of access. The worker level of access may include access to primary client logs stored in the database. Logs may include risk scores associated with the clients, flags indicating high risk, goals, and other data such as detailed information about the primary client and associated secondary clients. Workers also may have access to a record of query sets and responses thereto from primary and associated secondary clients. A worker may generate a new query set for a primary or secondary client from a question bank stored in database 304. Workers also have access to a messaging center that allows communication with a supervisor, a primary and/or secondary client, or other workers.

System software 324 retrieves the latest stored query set for the ID from database 304 in process 410 when access is attempted by a primary or a secondary client who is not a worker. System software 324 then downloads the query set in one or more Web pages displayed on the primary or secondary client computer 310-318. After server 302 receives all query sets, a risk assessment may be performed using query responses as measured input variables. Alternatively, the responses from some or all of the received query sets may be stored for the review of a worker before a risk assessment is performed. Once risk is assessed, the score is stored in database 304 in process 416. If the score does not indicate unacceptable risk, the system returns to standby mode, as indicated by path 418.

If high risk is present, process 420 may be implemented to check whether the ID is a member of the primary client's household (which includes the primary client). The purpose of process 420 is to provide the client with helpful resources corresponding to the client's query responses, as described above. It is to be understood that even when an assessment does not produce a high-risk score, a response to a query or query set may cause the system to generate helpful resources, alerts to visit a client in person, or notify a worker to do so. Of course, a worker may, at anytime deemed appropriate, generate a list of resources for any client. When the system determines unacceptable risk is present, process 424 generates a signal to alert the workers responsible for monitoring the primary client risk. The signal is a marker stored in database 304. The signal marker may be identified by system software 324 and displayed to workers in a variety of ways, such as described above. A worker accessible primary client log may be updated in process 425 to include the high-risk signal marker and any other information received from primary or secondary clients during system access.

When system input variables change a primary client's risk status, process 426 may be performed by system software 324 to notify a worker monitoring the primary client worker that the client's goal needs re-evaluation. Notification may take a form similar to the high risk signal marker previously described, whereupon access by a worker, the system may display to the worker indicia within a client listing, a client log, or a separate file storing the marker and a pointer to an associated client. Alternatively, system software 324 may automatically generate a new goal based on an algorithm within or accessible by the system software and store the new goal into database 304, or provide the generated goal to the worker as a recommendation. Although not shown in the process diagram of FIGS. 4a-4c, the risk assessment system may notify a worker to re-evaluate a client's goal and/or status when risk levels change from unacceptable levels to acceptable levels. Workers also may determine new goals for a primary client at any time deemed appropriate.

When a high-risk assessment is generated by system 300, the workers monitoring a primary client are notified of the high risk calculation and/or that follow-up communication to the client is necessary. This notification may be tied with a calendar scheduling application that is accessible by system software 324 to allow the worker an efficient planning tool. When a dangerously high-risk level is assessed for a primary client, system 300 may suggest other means of notification, such as notifying and providing instructions to local law enforcement officials, judicial oversight officials, or workers monitoring a primary client that immediate action should be taken.

In process 429, the next query set to be provided a primary or secondary client upon server access is updated and stored in database 304 by system software 324. Thereafter, system software 324 places server 302 in standby mode in process 430. Alternatively, system software 324 may notify a worker to update a query set without generating a query set. Worker notification in any of the above processes may be in the form of a message generated by system software 324 and displayed on a worker messaging application. Notification may instead, or in combination with a generated message, take the form of displayed indicia, such as described above with respect to high-risk markers, or a voice mail message, for example.

While the system of the present invention sends alert signals when risk scores reach unacceptable levels, system software 324 also can monitor whether a primary client's risk score remains above, below or near acceptable levels for a predetermined time. System 300 may then notify the client's caseworker or other administrative workers that the client may be eligible for removal from the system.

It is to be understood that the process thus described is exemplary of the present invention. Though processes illustrated in FIGS. 4a-4c are arranged in a consecutive manner, the order of execution shown in the figures is provided for conceptual purposes. Many processes shown or described above may be performed in a different order, simultaneously (in parallel), in a multi-tasked fashion, or omitted when practicing the present invention. Furthermore, while a composite risk score is discussed above as being associated with a “level,” it is to be understood that a level may be associated with a value within a range of values that define a particular classification category of risk, such as “low risk,” “mid risk,” or “high risk,” for example.

In contrast to conventional risk assessing systems and methods, the present invention allows continuous access to a risk monitoring system by an individual being assessed and/or others associated with the assessed individual, to provide “real time,” dynamic assessments. Because many of the aspects regarding risk assessment and risk management are automated, the system also provides efficient ways of managing worker caseloads that enable costs savings over conventional methods and systems. Automation and increased efficiency also enables caseworkers to better allocate and prioritize time devoted to each individual they monitor.

The system of the present invention provides a proactive method of managing risk by facilitating communication between those responsible for monitoring risk, those individuals being assessed for risk, and other individuals associated with the assessed individuals. Risk levels for an individual may be assessed within a single system (e.g., child welfare) or evaluated across multiple systems (e.g., education, mental health, and juvenile justice). Workers will be appraised of possible “hot” situations involving risk as they occur. The present invention also provides helpful resources to individuals to cool down or prevent hot situations from developing. A messaging application tied to the system of the present invention further promotes communication between individuals using the system. The messaging application can be Internet based application to provide greater privacy than present e-mail applications that may be accessed by individuals other than the primary or secondary client.

Social dynamics may differ from one locality to another. When using an adaptive risk assessment system application, the present invention can be trained using data sets representing a localized area to account for variables that may affect transfer function weights differently from one area to another.

While server access is described above with reference to Internet Web pages, it is to be understood that server access also may be allowed telephonically using known automated menu driven methods and systems, or through the help of a “hotline” operator having access to a system server of the present invention.

By fine tuning fuzzy logic systems or training adaptive systems of the present invention, workers and researchers in a particular field of risk may discover rules for determining risk that underlie raw measured data. Adaptive risk applications also provide a better understanding of how rules for various risk categories are developing over time. The present invention also facilitates a “smarter” risk assessment given the dynamics of a real world current situation. Thus, the system and methods disclosed herein thus provide society with insight into how and why particular variables affect risk as well producing as accurate and continuously updated risk assessment to better meet its demand for the safety and welfare of its members.

It will be apparent to those skilled in the art that various changes and modifications can be made without departing from the spirit and scope thereof. Thus, it is intended that the present invention cover the modifications of this invention provided they come within the scope of the appended claims and their equivalents.

What is claimed is:

1. A risk assessment system for evaluating and determining levels of risk, comprising:
a computer;
a memory accessible by the computer;
a first file stored in the memory and including data defining weighted profile characteristics of a first individual;
an interface component that allows the first individual and a set of second individuals associated with the first individual to access the first file and set at least one of the profile characteristics; and
a risk assessment application in the computer for computing and storing in the computer memory a risk score for the first individual using input based on the profile characteristics.

2. The system according to claim 1, wherein at least one of the profile characteristics has a weight based on a response to a query stored in the computer memory and accessed by one of the first individual and one of the set of second individuals.

3. The system according to claim 1, wherein the system is network based, and the computer is a network server computer.

4. The system according to claim 1, wherein the risk assessment application has an ability to learn from patterns within a set of measured input variables and thereby adjust the risk assessment application based on the patterns of the set of measured input variables.

5. The system according to claim 1, wherein the risk assessment application has an ability to adapt to changes by training the risk assessment application with data based on a set of known risk scores and respective sets of known input variables corresponding to the known risk scores.

6. The system according to claim 1, wherein the interface component comprises a telephonic connection between the first individual or the set of second individuals and the system computer.

7. The system according to claim 6, wherein the telephonic connection comprises a hot line operator.

8. The system according to claim 6, wherein the telephonic connection comprises a second computer and a modem.

9. The system according to claim 6, wherein the telephonic connection comprises a wireless device for accessing the Internet.

10. The system according to claim 3, wherein the first individual has a first privileged level of server access and the each of the set of second individuals has a respective privileged level of access to the first file, each respective level of access being based on a relationship between respective ones of the second set of individuals and the first individual.

11. The system according to claim 3, wherein the system memory includes one or more query files, and wherein a software application in the server generates query sets from the one or more query files for at least one of the first individual and the set of second individuals, and responses to the query sets are stored in the computer memory.

12. The system according to claim 11, wherein the profile characteristics correspond to query responses provided by the at least one of the first individual and the set of second individuals.

13. The system according to claim 10, wherein a subset of the set of second individuals level of access includes access to the composite risk score in the memory.

14. The system according to claim 1, wherein the computer includes software that compares the computed risk score with a predetermined value and generates a marker in the first file when the composite risk score meets or exceeds the predetermined value.

15. The system according to claim 14, wherein the marker is accessible by at least one of the set of second individuals.

16. A method of determining and monitoring a type of risk, comprising:
creating and storing in a memory accessible by a computer a first file including data defining profile characteristics of a first individual;
storing in the memory a risk assessment application for computing a composite risk score indicative of a level of the risk type;
computing the composite risk score by providing input based on the profile characteristics of the first file to the risk assessment application;
storing the composite risk score in the computer memory;
generating at least one first query set in the computer memory, wherein the query set corresponds to the risk type;
allowing the first individual or a second set of individuals associated with the first individual to access at least one question of the at least one first query set in the computer memory; and
allowing transmission of information corresponding to the profile characteristics, and based on responses to the at least one question of the at least one first query set from the first individual or second set of individuals associated with the first individual, to the computer and storing the information in the first file.

17. The method of claim 16, further comprising:
generating an alarm signal when the composite risk score exceeds a predetermined value or falls within a predetermined range of values.

18. The method of claim 17, further comprising:
storing data corresponding to the alarm signal in the computer memory and allowing at least one individual of the second set of individuals to access the data corresponding to the marker.

19. The method of claim 17, further comprising:
generating and storing in the computer memory at least one second query set, wherein the selection of at least one question for the second query set is based on changes in the first individual's profile characteristics causing said alarm signal.

20. The method of claim 16, wherein the information is transmitted within a computer network, and the computer is a server in the network.

21. The method of claim 19, further comprising:
storing on the server memory a software application allowing communication between the first individual and at least one individual of the second set of individuals, or between individuals of the second set of individuals.

22. The method of claim 19, further comprising:
providing the first individual or at least one individual of the second set of individuals with network resources based on a response to at least one question of the query set.

23. The method of claim 16, wherein the risk assessment application comprises a neural network and the method further comprises training the risk assessment application.

24. The method of claim 23, wherein the training of the risk assessment application is performed using a backpropagation technique.

25. The method of claim 16, wherein the risk assessment application comprises a neural network and the method further comprises training the risk assessment application using an input set of profile characteristics from a plurality of first individuals.

26. The method of claim 16, wherein the risk assessment application comprises a neural network and the method further comprises training the risk assessment application using at least one neural network and at least one live expert.
